(19) United States
(12) Patent Application Publication
(10) Pub. No.: US 2003/0080263 A1
(43) Pub. Date: May 1, 2003

(54) Accessory mounting adapter for a trailer hitch assembly

(76) Inventor: Richard W. McCoy, Granger, IN (US)

Correspondence Address: KING & SCHICKLI, PLLC, 247 NORTH BROADWAY, LEXINGTON, KY, 40507, US

(21) Appl. No.: 10/287,163

(22) Filed: Nov. 4, 2002

Related U.S. Application Data
(63) Continuation-in-part of application No. PCT/US01/30796, filed on Oct. 2, 2001.
(60) Provisional application No. 60/243,382, filed on Oct. 26, 2000.

(51) Int. Cl. A47H 1/10; E04G 3/00; B62C 1/06

(52) U.S. Cl. 248/205.1; 296/26.08; 280/477

(57) ABSTRACT

An accessory mounting adapter is provided for a trailer hitch assembly that includes a receiver box. The accessory mounting adapter includes a cross member. A mounting bar is connected to the cross member and allows the adapter to be secured in the receiver box of the trailer hitch assembly. A pair of accessory receivers are connected to the cross member. At least one of the accessory receivers has a first accessory mounting section for receiving a first type of accessory mounting post and a second accessory mounting section for receiving a second type of accessory mounting post. This greatly increases the versatility of the adapter to carry various accessories.

This application claims the benefit of U.S. Provisional Patent Application Serial No. 60/243,382 filed on Oct. 26, 2000 and is a continuation-in-part of patent application Serial No. PCT/US01/30796 filed on Oct. 2, 2001.

### TECHNICAL FIELD

The present invention relates generally to the vehicle accessory field and, more particularly, to an adapter for mounting accessories with multiple mounting post systems into the receiver box of a standard trailer hitch assembly.

### BACKGROUND OF THE INVENTION

It has long been known to construct towing hitches that are mounted to vehicles in order to allow the towing of trailers or the like. In recent years such hitches have been designed to include a receiver box having a rearwardly directed opening or cavity for the receipt of a hitch or draw bar that carries a hitch ball or other means allowing connection to a trailer. Examples of such a structure include the Insta-Hitch II and Custom Hitch Receiver 35365 as manufactured by Reese Products, Inc. of Elkhart, Ind. Such a hitch receiver is also disclosed in, for example, U.S. Pat. No. 3,768,837 to Reese, owned by Reese Products, Inc.

Recent efforts to enhance the versatility of a hitch receiver have led to development of various accessories (e.g., both open and closed article carriers, bike racks, ski racks, tables, winches or other equipment) mounted by means of an accessory mounting bar or lug in the receiver box of a trailer hitch receiver assembly. Because of their convenience and suitability to the particular applications/interests of the user, such accessories have become very popular.

In order to allow for or accommodate trailer towing and accessory mounting simultaneously, a trailer hitch assembly with both a trailer hitch receiver and towing accessory receivers has been recently developed and is the subject of, for example, U.S. Patent Application Serial No. 60/194,502, filed Apr. 3, 2000 and No. 60/243,486, filed Oct. 26, 2000. This new trailer hitch receiver assembly includes a central frame member, a mounting bracket carried on each end of the central frame member for securing the central frame member to the vehicle, a hitch receiver box carried on the central frame member and two accessory receivers for receiving and holding a recreational and/or utilitarian accessory. The two point mounting for the accessory greatly increases the stability of the mounting arrangement. Accordingly, a number of accessories will be manufactured and marketed with multiple mounting posts, brackets, lugs or bars in order to take advantage of this new arrangement.

The present invention relates to an adapter that may be utilized to mount accessories manufactured with the new multiple mounting lug, bar, bracket or post systems on “standard” trailer hitch assemblies that incorporate only a hitch receiver. Thus, the old trailer hitch assemblies in the field may be conveniently adapted to receive and hold the new multipost/multibar/multibracket mounting accessory products.

### SUMMARY OF THE INVENTION

In accordance with the purposes of the present invention as described herein, an accessory mounting adapter is provided for a trailer hitch assembly incorporating a receiver box. The adapter includes a cross member, a mounting bar carried on the cross member for securing in the receiver box of the trailer hitch assembly and a pair of stepped accessory receivers allowing two-point mounting of an accessory of a type incorporating multiple mounting posts, brackets or bars.

More particularly describing the invention, the mounting bar may be square or round in cross section and the accessory receivers may be rectangular in cross section and of solid metal construction. Of course, the cross sections described and illustrated in this patent application are simply to be considered illustrative of possible cross sections that may be used and not limiting in determining the scope of the present invention. The stepped accessory receivers project upwardly from the cross member at an acute included angle (i.e. from about 10° to about 30°) and include a side wall having a pair of opposed apertures for receiving a pin to secure an accessory thereto. The mounting bar also includes a pair of opposed side walls each including a pin receiving aperture whereby the adapter may be secured in the receiver box of a trailer hitch assembly.

The invention may also be described as comprising a T-shaped body carrying a pair of stepped accessory receivers allowing for two point mounting of an accessory.

Still further, the present invention may be alternatively described as an accessory mounting adapter including a cross member, a mounting bar connected to the cross member and a pair of accessory receivers connected to the cross member. At least one accessory receiver of that pair of accessory receivers has first and second accessory mounting sections.

More particularly, the first accessory mounting section is sized and shaped for receiving a first type of accessory mounting post/bracket. In contrast, the second accessory mounting section is sized and shaped for receiving a second type of accessory mounting post/bracket. This arrangement greatly increases the versatility of the mounting adapter to receive and support different accessories.

Still further, the accessory receiver includes first and second cooperating stops to aid in properly seating the two types of accessory mounting posts/brackets on the accessory receiver. The first stop is provided on the accessory receiver between the first and second accessory mounting sections.

In the following description, there is shown and described a preferred embodiment of this invention, simply by way of illustration of one of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention and together with the description serve to explain certain principles of the invention. In the drawings:

FIG. 1 is an exploded perspective view of a typical or standard trailer hitch assembly incorporating a single centrally located receiver box as commonly utilized to tow a trailer, the adapter of the present invention and an accessory;

FIG. 2 is a side elevational view of the adapter shown in FIG. 1;

FIGS. 3a and 3b illustrate how the adapter is utilized to mount an accessory including a first type of two-point mounting post system to a trailer hitch assembly incorporating only a receiver box;

FIGS. 4a and 4b illustrate how the adapter is utilized to mount an accessory including a second type of two-point mounting post system to the same trailer hitch assembly incorporating only a receiver box; and

FIG. 5 is a detailed cross-sectional view showing the securing of the mounting bar of the adapter in the receiver box of the trailer hitch assembly utilizing a tightener.

Reference will now be made in detail to the present preferred embodiment of the invention, an example of which is illustrated in the accompanying drawings.

### DETAILED DESCRIPTION OF THE INVENTION

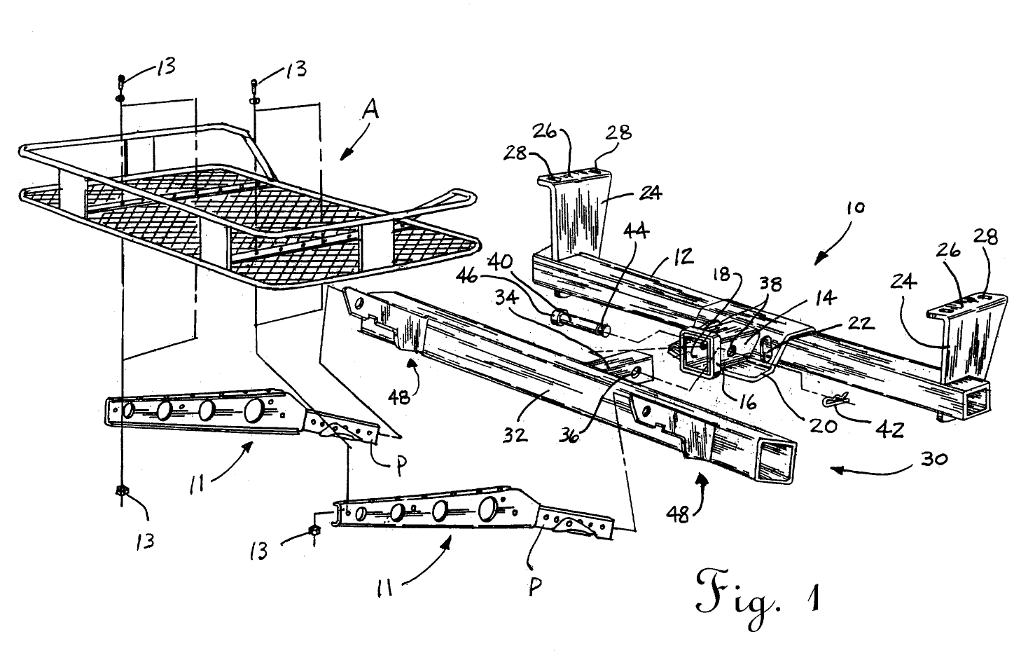

Reference is now made to FIG. 1 illustrating a typical or standard trailer hitch receiver assembly, generally designated by reference numeral 10 which is mounted to the frame of a towing vehicle, the adapter 30 of the present invention and an accessory A. The accessory A is mounted to a pair of support assemblies 11 incorporating mounting brackets or post P, P′ by means of cooperating nut and bolt fasteners 13.

The trailer hitch assembly 10 includes a cross bar 12 formed from tubular steel. A receiver box 14, also formed from tubular steel, is welded to the cross bar 12. The receiver box 14 includes a reinforced lip 16 defining a cavity 18 sized and shaped to receive and hold a hitch or draw bar (not shown) of the type that carries a hitch ball or other means allowing connection to a trailer. A chain plate 20 formed from a steel plate is welded to both the cross bar 12 and receiver box 14 to enhance the rigidity of the overall structure and provide openings 22 for receiving the safety chains of a trailer during towing.

The trailer hitch assembly 10 also includes a pair of mounting brackets 24 which may also be formed from steel plate material. One mounting bracket 24 is welded to the cross bar 12 adjacent each end thereof. Each mounting bracket 24 includes a mounting flange 26 and each mounting flange includes two or more apertures 28. Nut and bolt fasteners (not shown) are extended through these apertures 28 and cooperating apertures drilled in the frame of the towing vehicle in order to mount the trailer hitch assembly 10 thereto.

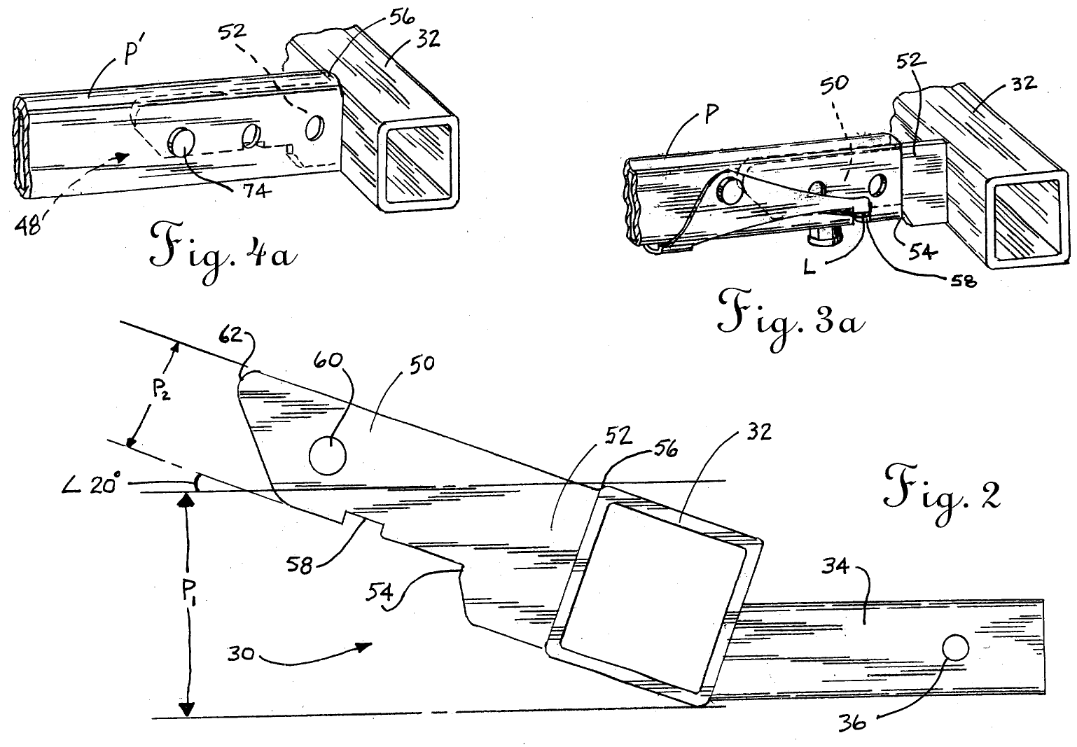

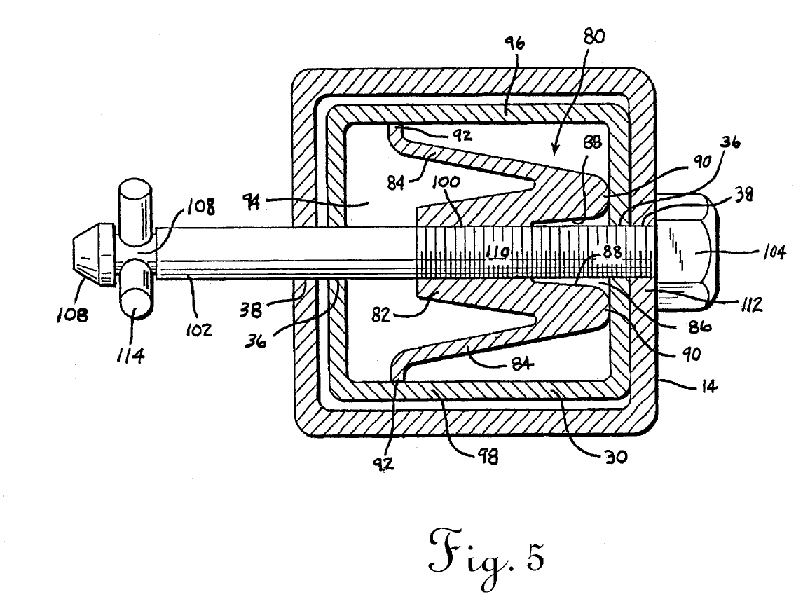

The accessory mounting adapter 30 of the present invention is shown in FIGS. 1 and 2. The adapter 30 includes a T-shaped body having a cross member 32 and a mounting bar 34 that may both extend in a first plane P₁. The mounting bar 34 is sized, shaped and adapted for receipt in the receiver box 14 of the trailer hitch assembly 10. When properly mounted in the receiver box 14, cooperating apertures 36 in the side walls of the mounting bar 34 are aligned with cooperating apertures 38 in the opposing side walls of the receiver box. A connecting pin 40 is passed through the apertures 36, 38 and a pin clip 42 is secured in the groove 44 on the end of the connecting pin opposite the head 46 (see also FIGS. 4a and 4b). The cross member 32 and the mounting bar 34 may both be formed from steel tubing and then secured together as an integral component by welding or other appropriate means.

Multiple stepped accessory receivers 48 are mounted to and carried on the cross member 32. Each accessory receiver 48 may be formed from solid steel material. Each accessory receiver 48 may be rectangular in cross section as illustrated or be of some other cross section suitable for the intended purpose or use (e.g. circular, hexagonal). One accessory receiver 48 is welded to the cross member 32 adjacent each end thereof.

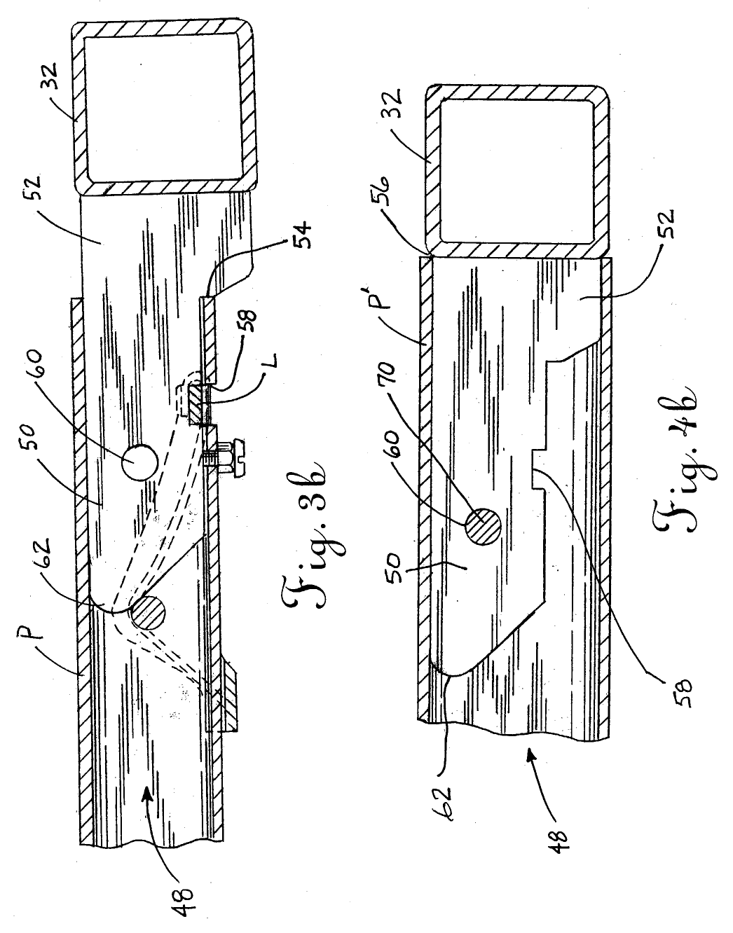

As shown in FIG. 2, at least one and, more typically, both receivers 48 project for receiving a mounting bracket or post P of an accessory A (see also FIGS. 4a and 4b). As further shown in FIGS. 3a and 3b, each receiver 48 projects upwardly in a plane P₂. As shown in FIGS. 3a and 3b, planes P₁ and P₂ define an acute included angle of, for example, between about 1° to about 89° and more typically about 10° to about 30° (e.g. 20°).

It should be appreciated that the structural arrangement of the mounting bar 34 and accessory receivers 48 benefits the user when attempting to attach a recreational and/or utilitarian accessory. When attached to the trailer hitch assembly 10, the accessory mounting adapter 30 projects rearwardly out from under the bumper of the vehicle to which the towing hitch assembly is secured. Additionally, the accessory receivers 48 project upwardly at an angle of from about 1° to about 89° and more typically from about 10° to about 30° (e.g. 20°) with respect to the mounting bar 34 and cross member 32 (i.e. the horizontal). Thus the accessory receivers 48 are both readily visible and accessible.

At least one and more typically both of the two accessory receivers 48 include a first accessory mounting section 50 and a second accessory mounting section 52. The first accessory mounting section 50 is shaped and dimensioned to receive a first type of accessory mounting post P. In contrast, the second accessory mounting section 52 is shaped and dimensioned to receive a second type of accessory mounting post P′.

In addition, the accessory receiver 48 includes a first stop 54 and a second stop 56. The first stop 54 is provided on the accessory receiver 48 between the first and second accessory mounting sections 50, 52. Still further, the first accessory mounting section 50 includes a latching notch 58 and a pin receiving locking aperture 60. Additionally, the first accessory mounting section 50 may also include a rounded projecting tip 62.

As will be appreciated from the following description, the accessory mounting adapter 30 of the present invention advantageously allows a user to connect accessories including two different types of multi-point mounting post systems to a trailer hitch assembly 10 incorporating only a receiver box 14.

Reference is now made to FIGS. 3a and 3b illustrating the connection of the adapter 30 to an accessory A including a first type of mounting post system. More specifically, the mounting post P includes an aperture that is aligned over the tip 62. The rounded shape of the tip 62 aids in aligning the post P for connection. Once aligned, the post P is pushed down over the receiver 48 until the end of the post P engages the first stop 54. In this position the post P is properly seated and a pivoting latching element L on the post P is received in the latching notch 58 to secure the post in position.

A second post P of the accessory A may be simultaneously secured to the other receiver 48 in the same manner in order to complete the connection of the accessory to the adapter 30 and, through the adapter to the trailer hitch receiver assembly 10.

The connection of the adapter 30 to an accessory incorporating a second type of mounting post system is illustrated in FIGS. 4and and 4b. In this embodiment the post P′ is once again aligned with and inserted over the accessory receiver 48. Again, the rounded tip 62 of the receiver 48 aids in completing this connection.

Once the post P′ is fully seated against the second stop 56, apertures A in the post P′ are aligned with the locking aperture 60 in the receiver 48. A connecting pin 70 is then inserted through the apertures A and 60. A clip 72 is then inserted on the end of the pin 70 so that the head 74 of the pin and the clip function to hold the pin in the desired locking position to thereby secure the post P′ to the receiver 48 and, therefore, the adapter 30. The second post of the accessory may be simultaneously mounted on the other receiver 48 in the same manner in order to complete the connection of the accessory A to the adapter 30 and therefore to the trailer hitch receiver assembly 10.

Of course, it should also be appreciated that the accessory receivers 48 project rearwardly out from under the bumper of the vehicle to which the towing assembly 10 is secured. Additionally, the receivers 48 project upwardly at an angle of from about 1° to about 89° and more typically about 10° to about 30° with respect to the mounting bar 34 and the cross member 32. Thus, the receivers 48 are both readily visible and accessible. Further, the posts P, P′ of the accessories A may be flexed slightly in virtually any direction during mating as an additional aid when making the connection.

Still further, the upward angular orientation of the receivers 48 ensures a secure connection between the posts P, P′ and the receivers. Specifically, this arrangement ensures that gravity works with the operator to properly seat the posts P, P′ on the receivers 48 against the stops 54, 56 during connection of the accessory A. The upward inclination also functions to effectively raise the accessory A from the ground so that it will clear most curbs and other like obstacles that one might expect to meet during vehicle operation such as when backing against a bumper or curb in a parking space.

Still further, the upward inclination also introduces a moment into the linkage between the accessory A and the receiver assembly 10 so that forward acceleration of the vehicle does not produce only rearward movement forces on the accessory.

In accordance with yet another aspect of the present invention, as best illustrated in FIG. 5 the adapter 30 may include an optional tightener, generally designated by reference numeral 80, to positively secure the adapter in the receiver box 14 and prevent rattling. Such a tightener is described in detail in pending U.S. patent application Ser. No. 09/981,515, filed Oct. 16, 2001 and entitled “Hitch Bar Tightener”, the disclosure of which is fully incorporated herein by reference.

As illustrated in FIG. 5, the tightener 80 has a body including an intermediate section 82 and a pair of projecting mounting lugs 84. Each projecting mounting lug 84 forms an included angle with the intermediate section 82 of between 0-35 degrees and more typically 10-30 degrees. A channel 86 is provided in the intermediate section 82. The channel 86 opens in a direction away from the projecting mounting lugs 84 and together with the mounting lugs provides the body with an overall, substantially W-shape. The sidewalls 88 of the channel 86 and the proximal ends of the mounting lugs 84 come together to form a pair of spaced shoulders 90. It should further be appreciated that each of the projecting mounting lugs 84 includes a beaded tip 92 at a distal end thereof. As will be described in greater detail below, the shoulders 90 and the beaded tips 92 function together to provide secure and stable mounting of the tightener 80 within the mounting bar 34.

More specifically, it should be appreciated that the mounting bar 34 is formed from square tubular steel material and, as such, includes a lumen or tubular opening 94. The tightener 80 is adapted to be mounted within the lumen 94 of the mounting bar 34. The tightener 80 is formed from aluminum which is a fairly soft material that allows the projecting mounting lugs 84 to be positioned to form an included angle of between 0-35 degrees with the intermediate section 82 of the tightener so as to provide a span between the beaded tips 92 of the mounting lugs necessary to snugly engage the upper and lower walls 96, 98 of the mounting bar 34. The tightener 80 may be positioned in the lumen 94 of the mounting bar 34 by driving in place with a hammer or any other appropriate means until the threaded aperture 100 in the intermediate section 82 is directly aligned with the apertures 36 in the sidewall of the mounting bar 34. As the tightener 80 is driven into place in the lumen 94, the beaded tips 92 are flattened against the upper and lower walls 96, 98 of the mounting bar 34. The inherent resiliency of the aluminum material ensures good contact and a secure friction fit is provided by the concentration of forces along the line of the beaded tips 92.

With the tightener 80 seated in the lumen 94 as described, the mounting bar 34 may now be inserted into the receiver box 14 of the trailer hitch assembly 10. Specifically, the end of the mounting bar 34 is aligned with and inserted into the cavity defined by the receiver box 14 until the apertures 36 in the mounting bar are aligned with the apertures 38 in the sidewalls of the receiver box. The threaded mounting bolt 102 is then inserted into the aligned apertures 36, 38 and the threaded aperture 100. More particularly, the threaded mounting bolt 102 includes an enlarged head 104 at a first end preferably in the form of a hexagonal bolt head. The second end of the mounting bolt 102 includes a frustoconical tip 106 to aid in locating the bolt in the aperture 38, and an adjacent groove 108.

When the threaded mounting bolt 102 is properly aligned and located in the aperture 38 in the first sidewall of the receiver box 14, it may then be pushed through the aperture 36 in the first sidewall of the mounting bar 34, the threaded aperture 100 in the intermediate section 82 of the tightener 80 and the apertures 36 and 38 in the opposite sidewalls of the mounting bar and receiver box 14, respectively, until the threaded portion 110 of the mounting bolt 102 engages the threaded aperture 100 of the tightener. At this point the bolt 102 is tightened by turning clockwise. A wrench may be used to engage the hexagonal head 104 of the bolt in order to complete the connection.

If the tightener 80 is not already secured in the lumen 94 of the mounting bar 34 with the shoulders 90 butting against the sidewall of the mounting bar, initial tightening of the bolt 102 causes the tightener to become seated in the mounting bar with the shoulders 90 tightly engaging the sidewall 112. The shoulders 90 provide two engagement lines which concentrate the frictional holding force to further tightly and positively secure the tightener 80 in the lumen 94 with the threaded aperture 100 aligned with the apertures 36 in the mounting bar 34. Continued tightening of the mounting bolt 102 causes the mounting bar 34 to be drawn tightly against the sidewall 112 of the receiver box 14. In this position any potential for the mounting bar 34 rattling in the receiver box 14 is virtually eliminated. When the mounting bolt 102 is properly seated as disclosed, a pin clip 114 is then positioned over the groove 108 on the second end of the mounting bolt to complete a secure connection of the mounting bar 34 in the receiver box 14 of the trailer hitch assembly 10.

The foregoing description of the preferred embodiment of this invention has been presented for purposes of illustration and description. It is not intended to be exhaustive or to limit the invention to the precise form disclosed. Obvious modifications or variations are possible in light of the above teachings. For example, while only two accessory receivers 48 are shown on the accessory mounting adapter 30, substantially any reasonable number may be provided to allow multipoint connection between the adapter 30 and the accessory A carried thereby. Further, materials other than steel may, of course, be utilized to construct any or all of the component parts of the apparatus including the trailer hitch assembly 10, the accessory mounting adapter 30 and the mounting posts P, P′ of the accessory A.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

In the claims:

1. An accessory mounting adapter for a trailer hitch assembly including a receiver box, comprising:
a cross member;
a mounting bar carried on said cross member, said mounting bar extending in a first plane P₁; and
a pair of stepped accessory receivers allowing two-point mounting of an accessory, said pair of stepped accessory receivers extending in a second plane P₂ where P₁ and P₂ define an acute included angle.

2. The adapter of claim 1 wherein said mounting bar is square in cross section.

3. The adapter of claim 1, wherein said pair of accessory receivers are rectangular in cross section.

4. The adapter of claim 1, wherein each of said pair of accessory receivers project from said cross member and include an aperture for receiving a pin to secure an accessory thereto.

5. The adapter of claim 1 further including a notch in each stepped accessory receiver of said pair of stepped accessory receivers.

6. The adapter of claim 1, wherein said mounting bar includes a pair of opposed side walls, each of said pair of opposed side walls including a pin receiving aperture whereby said adapter is secured in the receiver box of the trailer hitch assembly.

7. The adapter of claim 1, wherein said included angle is from about 1° to about 89°.

8. The adapter of claim 1, wherein said included angle is from about 10° to about 30°.

9. The adapter of claim 1, wherein said included angle is about 20°.

10. The adapter of claim 1 further including a tightener.

11. The adapter of claim 10, wherein said tightener includes (a) a body having an intermediate section with a threaded aperture and a pair of projecting mounting lugs and (b) a threaded mounting bolt engaging said threaded aperture in said body.

12. An accessory mounting adapter for a trailer hitch assembly including a receiver box, comprising:
a T-shaped body; and
a pair of stepped accessory receivers carried on said T-shaped body allowing for two-point mounting of an accessory.

13. The adapter of claim 12, wherein said pair of accessory receivers are rectangular in cross section.

14. The adapter of claim 12, wherein said pair of accessory receivers are constructed from solid material.

15. The adapter of claim 12 further including a tightener.

16. The adapter of claim 15, wherein said tightener includes (a) a body having an intermediate section with a threaded aperture and a pair of projecting mounting lugs and (b) a threaded mounting bolt engaging said threaded aperture in said body.

17. An accessory mounting adapter for a trailer hitch assembly including a receiver box, comprising:
a cross member;
a mounting bar connected to said cross member; and
a pair of accessory receivers connected to said cross member;
said accessory mounting adapter being characterized by at least one accessory receiver of said pair of accessory receivers having a first accessory mounting section for receiving a first type of accessory mounting post and a second accessory mounting section for receiving a second type of accessory mounting post.

18. The accessory mounting adapter of claim 17, further including a first stop and a second stop on said at least one accessory receiver.

19. The accessory mounting adapter of claim 18, wherein said first stop is provided on said at least one accessory receiver between said first and second accessory mounting sections.

20. The accessory mounting adapter of claim 19, wherein said first accessory mounting section includes a latching notch.

21. The accessory mounting adapter of claim 19, wherein said first accessory mounting section includes a locking aperture.

22. The accessory mounting adapter of claim 19, wherein said first accessory mounting section includes a latching notch and a locking aperture.

23. The adapter of claim 17 further including a tightener.

24. The adapter of claim 23, wherein said tightener includes (a) a body having an intermediate section with a threaded aperture and a pair of projecting mounting lugs and (b) a threaded mounting bolt engaging said threaded aperture in said body.

25. An accessory mounting adapter for a trailer hitch assembly including a receiver box, comprising:
a cross member;
a mounting bar carried on said cross member;
a tightener carried on said mounting bar; and
at least two accessory receivers carried on said cross member.

26. The adapter of claim 25, wherein said tightener includes (a) a body having an intermediate section with a threaded aperture and a pair of projecting mounting lugs and (b) a threaded mounting bolt engaging said threaded aperture in said body.
